(19) United States
(12) Patent Application Publication
(10) Pub. No.: US 2016/0094354 A1
(43) Pub. Date: Mar. 31, 2016

(54) Multi-Device Simultaneous Content Sharing

(71) Applicant: Cisco Technology, Inc., San Jose, CA (US)

(72) Inventors: Qiujun Zhao, HANGZHOU (CN); Benny Lv, HANGZHOU (CN); Jiong Tu, HANGZHOU (CN); Niko Ni, HANGZHOU (CN)

(21) Appl. No.: 14/500,048

(22) Filed: Sep. 29, 2014

(51) Int. Cl. H04L 12/18; H04L 29/06

(52) U.S. Cl. CPC H04L 12/1822; H04L 65/403

(57) ABSTRACT

Methods, apparatuses, and computer readable storage media for allowing a presenter to share content from multiple devices in a web conference. In an embodiment, the presenter joins the conference using a main computing device. Using the main device, the presenter takes control of meeting client(s) at one or more other respective computing devices external to the main computing device. Content at the other devices is then selected and transferred to the main computing device. The selected content is then presented through the conference to other participants in the conference.

### TECHNICAL FIELD

The present disclosure relates to web conferencing.

### BACKGROUND

In current web conferencing systems, a presenter can generally share content with other participants in the conference. The content is shared using the presenter's computing device, through which he or she participates in the conference. This computing device may be a desktop personal computer, a laptop, a tablet computer, a smartphone, etc. The content may be a stored file at the presenter's computing device, and may be displayed at the presenter's computing device through an application program. A chart may be displayed through a spreadsheet program, or a video may be displayed through a media player application, for example. Alternatively, the content may be streamed to the presenter's computing device, and shared. A web browser may be used for this purpose, for example.

A presenter may have more than one computing device, however, and he may typically use them for various purposes and situations. He may use a desktop computer at his office, but may use a smartphone when commuting and use a laptop when on business trips. As a result, he may use different applications on different computing devices, and may have different content stored on each.

### BRIEF DESCRIPTION OF THE DRAWINGS

FIG. 1 illustrates a web conferencing system, according to an example embodiment.

FIG. 2 illustrates interaction between a main computing device and a presenter's other devices, according to an example embodiment.

FIG. 3 is a flowchart illustrating the processing described herein, according to an example embodiment.

FIG. 4 is a flowchart illustrating the transfer of content to the main device, according to an example embodiment.

FIGS. 5A-5D show display screens at the main device, according to example embodiments.

FIG. 6 is a flowchart illustrating the manipulation of content, according to an example embodiment.

FIG. 7 is a block diagram illustrating a computing environment for the processing described herein, according to an example embodiment.

### DESCRIPTION OF EXAMPLE EMBODIMENTS

### Overview

Described herein are methods, apparatuses, and computer readable storage media for allowing a presenter to share content from multiple devices in a web conference. In an embodiment, the presenter joins the conference using a main computing device. Using the main device, the presenter takes control of meeting client(s) at one or more other respective computing devices external to the main computing device. Content at the other devices is then selected and transferred to the main computing device. The selected content is then presented through the conference to other participants in the conference.

### Example Embodiments

A presenter may have more than one computing device, and he may typically use them for various purposes and situations. He may use a desktop computer at his office, but may use a smartphone when commuting and use a laptop when on business trips. As a result, he may use different applications on different computing devices, and may have different content stored on each. This creates a problem in web conferencing scenarios, when the presenter may be using one computing device to take part in the conference, but the content that he wishes to share may reside on or be accessible through another of his computing devices. In such a situation, the content on his other devices is not readily available to be shared in the web conference.

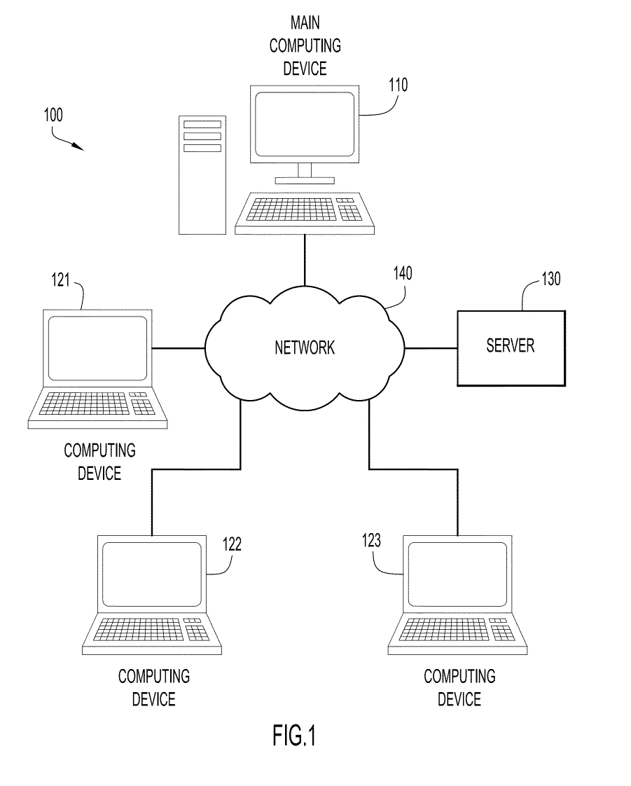

Referring to FIG. 1, an example of a web conferencing system is shown. Using the illustrated system 100, users can have an online web conference (e.g., a web meeting) in which they can share voice, video, images, and/or other types of data through computing devices 110 and 121, 122, 123 over network 140. A presenter's main computing device 110 represents a computing and communications device, such as a desktop or laptop computer, or a mobile device, such as a tablet or smart phone. As used herein, the term “main” refers to an arbitrary first computing device of a potential plurality of other computing devices, operated by a user (e.g., a presenter) in the context of an online/web conference. While the main device 110 may be a general purpose computing device, main device 110 may alternatively be a special purpose computing and communications device, used specifically for web conferencing. Other users in the conference call may view, hear, speak, or otherwise take part in the conference call using their own computing devices 121, 122, 123. As in the case of main device 110, the computing devices 121, 122, 123 may be any of a variety of computing and communication devices, such as such as a desktop or laptop computer, or a mobile device, or a special purpose web conferencing device. While the main computing device 110 is shown in communication with three other participating devices, various web conferencing systems may in practice have more or less than this number.

Network 140 may be any type of network (e.g., any combination of Internet, intranet, local area network (LAN), wide area network (WAN), wired network, wireless network, etc.) that connects computing devices, e.g., main device 110 and participants' computing devices 121, 122, 123. Server 130 is used to mediate communications between and among main device 110 and the participants' devices 121, 122, 123. In various embodiments, server 130 may perform caching of data shared among users. In the illustrated conferencing system, each device may communicate with the server 130 through a browser application having one or more plug-ins that enable a network-based meeting experience. The browser allows for the transmission of data to the server 130, and the receipt of data from the server 130 during a web conference. In alternative embodiments, a browser is not used. Instead a different, dedicated software application may be used to reach other devices and server(s) in a conference.

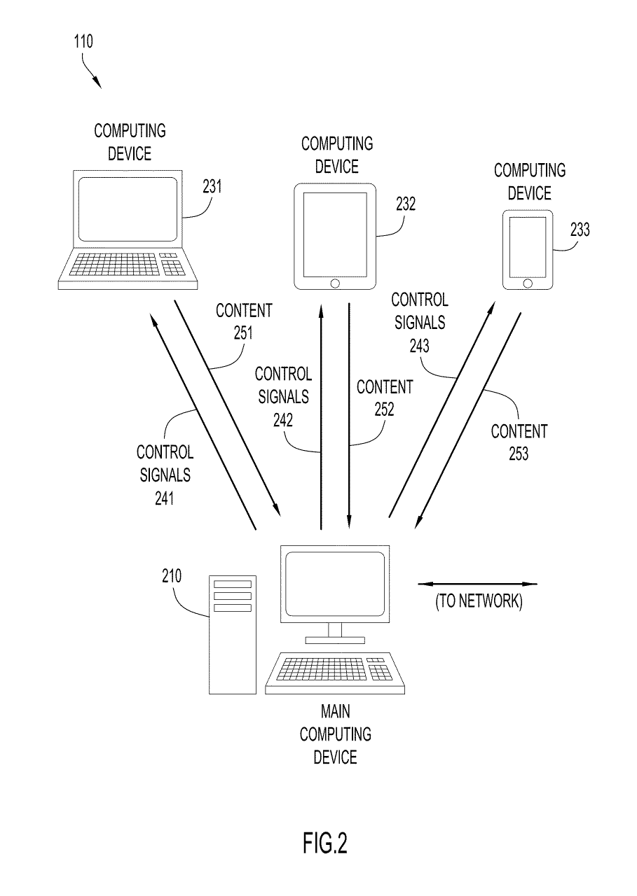

FIG. 2 illustrates the interaction between a presenter's main computing device 210 (analogous to main computing device 110 in FIG. 1) and the presenter's other computing devices 231-233, according to an embodiment. The main computing device 210 represents the device through which the presenter can obtain content from his other devices and through which he can take part in a web conference. By so doing, the presenter can share this content with participants in the web conference. The additional content may reside on, or otherwise be accessed through, these one or more other computing devices. In an embodiment, these other computing devices are separate and distinct from the main device 210. The other computing devices may include, for example, a laptop computer 231, a tablet computer 232, and a smartphone 233. These represent examples of a presenter's other devices, and are not meant to be limiting.

As will be described in greater detail below, the main computing device 210 allows the presenter to remotely control some of the functionality of each of the other computing devices. In particular, the main device 210 takes control over the meeting client of computing device 231. The main device 210 may also take control over an application program that is running on device 231 and that processes and outputs content that the presenter wishes to share in the web conference. In order to exert control over the meeting client and application program, control signals 241 are sent from the main computing device 210 to the computing device 231. The control signals 241 are based on input of the presenter. In this manner, the presenter may take control of the meeting client and application program at device 231. Using these control signals 241, particular content may be selected and ultimately transferred to main device 210. In a similar manner, the main device 210 may take control of processes on any of the other computing devices 232 and 233 by sending respective control signals 242 and 252 to these devices. These control signals then allow the main computing device 210 to obtain content from these devices, shown as content 252 and 253 respectively. The received content can then be aggregated at the main device 210 and provided to other participants in the web conference through a connection to a network as shown.

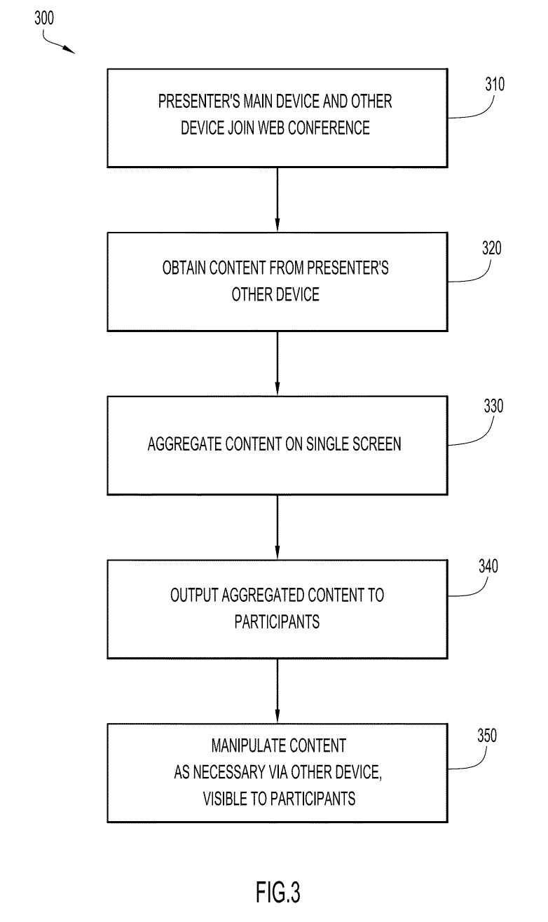

Processing in such a system is described in FIG. 3, according to an embodiment. While the processing is described below with respect to the main device and another device of the presenter, it is to be understood that in the course of a single web conference, the processes may also take place with respect to multiple other devices of the presenter.

At 310, the presenter, using the main computing device, joins the web conference. Another device of the presenter also joins the conference. At 320, content is obtained from the other device. As noted above, the presenter takes control of the meeting client and application program at the other device using the main device, to make the content transfer possible. This will be described in greater detail below.

At 330, this content is aggregated at the main device of the presenter. The content may be aggregated and formatted on a single screen. In an embodiment, this aggregation and formatting includes arrangement of the content on a display of the main device according to the presenter's input. Content from different devices, including the main device, may be displayed in different windows, for example, where the windows may be sized and/or overlapped at the presenter's discretion. Alternatively, the content may be organized in different viewing areas that overlap completely but are accessible through different tabs, as is sometimes seen in web browsers. At 340, the aggregated content is collectively output to the other participants in the web conference. As illustrated in FIG. 1, this transmission of content to the conference participants may take place via a conference server. At 350, the presenter may manipulate the content. This manipulation may take place through control of the associated application(s) at the other device. In an embodiment, the manipulation takes place in a manner that is visible to the other participants in the web conference.

In an embodiment, the status of a given device as either the main device (e.g., device 210 in FIG. 2) or another device (e.g., device 231, 232, or 233) is not necessarily permanent. For a subsequent web conference, a different device may serve as the main device. Moreover, in the course of a given web conference, one of the other devices may assume the role of the main device. In a manner similar to the process described above with respect to FIG. 3, this device would assume control of the meeting clients and applications of the other devices. In such cases, content would be obtained by and aggregated this other device, which would now be operating as the main device. Such a reconfiguration may be initiated by the presenter, for example.

In addition, the fact that a meeting client and/or application(s) of another device are controlled remotely through a main device can also be changed. In particular, a device that is being controlled remotely in this manner may resume control of its meeting client and/or application(s). In an embodiment, this may be initiated by the presenter.

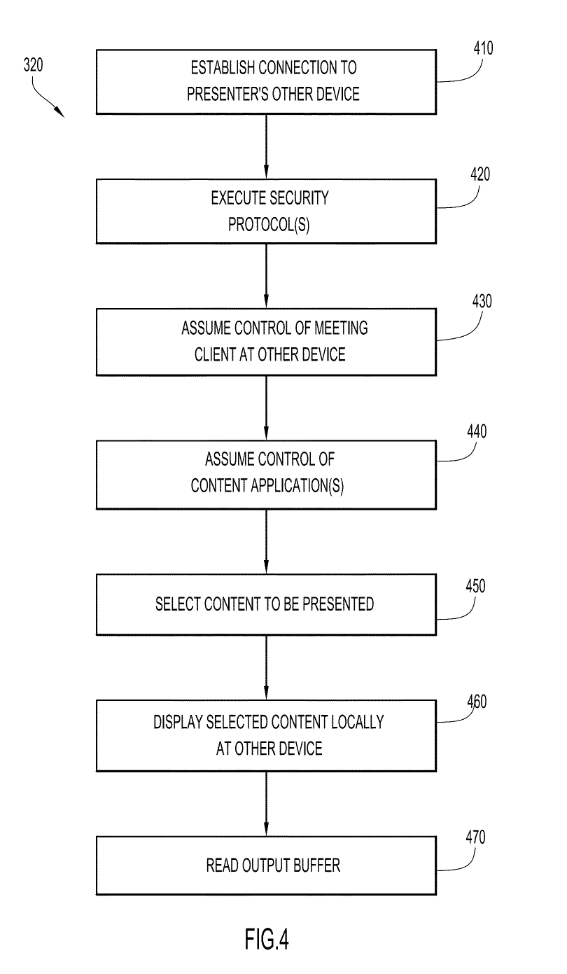

Obtaining content from the presenter's other device (320 of FIG. 3) is illustrated in greater detail in FIG. 4, according to an embodiment. At 410, a connection is established between the main device and the presenter's other device. In various embodiments, this connection may be established through a network such as network 140 of FIG. 1, and/or may be established through a local area network at the presenter's facility, for example. Known protocols may be used to establish the connection, such as the transmission control protocol (TCP) or user datagram protocol (UDP). At 420, a security protocol may be executed that allows the presenter to securely access content on the other device. In such an embodiment, the security protocol may include cryptographic processes to authenticate the presenter and/or the main device, and ensure that unauthorized parties do not access the presenter's other device. In this embodiment, such a security protocol may include public key operations and the use of signed certificates, as would be understood by a person of ordinary skill in the art.

At 430, the presenter, using the main device, assumes control of the meeting client at the other devices. At 440, the presenter can take control of one or more particular applications that operate on content at the other device. At 450, content at the other device may be selected. Operations 430-450 are initiated by the presenter, in the form of inputs provided by the presenter through a user interface at the main device. In an embodiment, these inputs are converted to control signals that are sent from the main device to the other devices through the connection(s) established at 410.

At 460, the selected content is displayed locally at the other device. This may be done through the respective applications operating on the selected content. At 470, the output buffer of the other device is read by the main device. In this manner, the content is transmitted to the main device. In various embodiments, the transferred content may be unstructured, or may be structured as a file. In an embodiment, the transferred content may represent data that has been streamed to the other device.

Note that the presenter, through the main device, accesses the other device in a variety of ways. As described above, a connection with the other device is established. Control is then exercised over the meeting client and an application at the other device. In addition, the output buffer of the other device is accessed. All these forms of access may require modification of security policies and/or software in the other device to permit such access, as would be understood by persons of ordinary skill in the art. As described above, security protocols may also have to be executed in conjunction with such access in order authenticate the presenter and/or the main device.

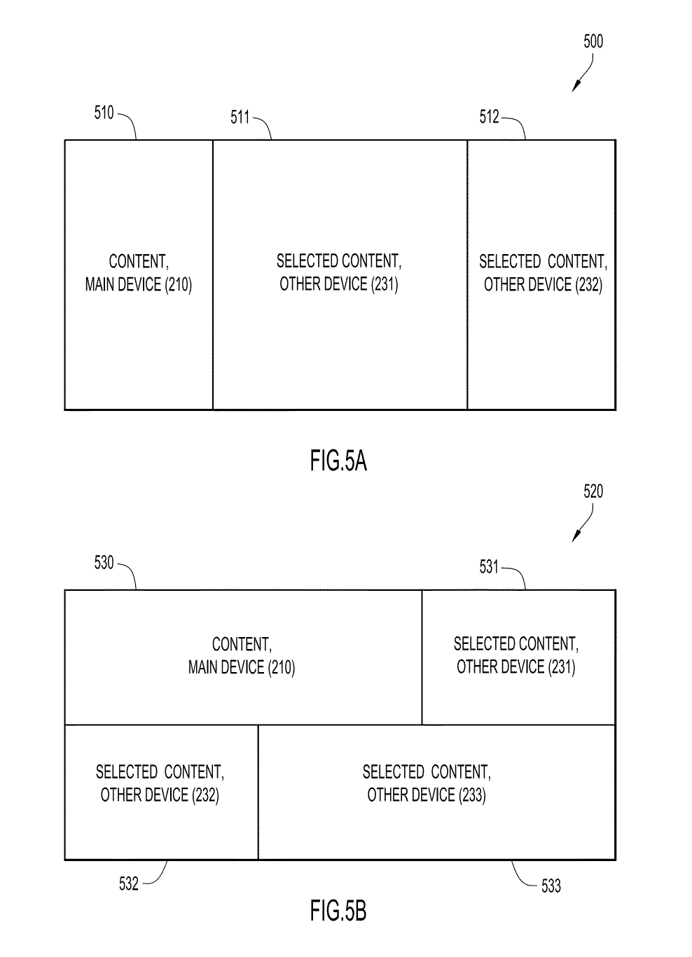

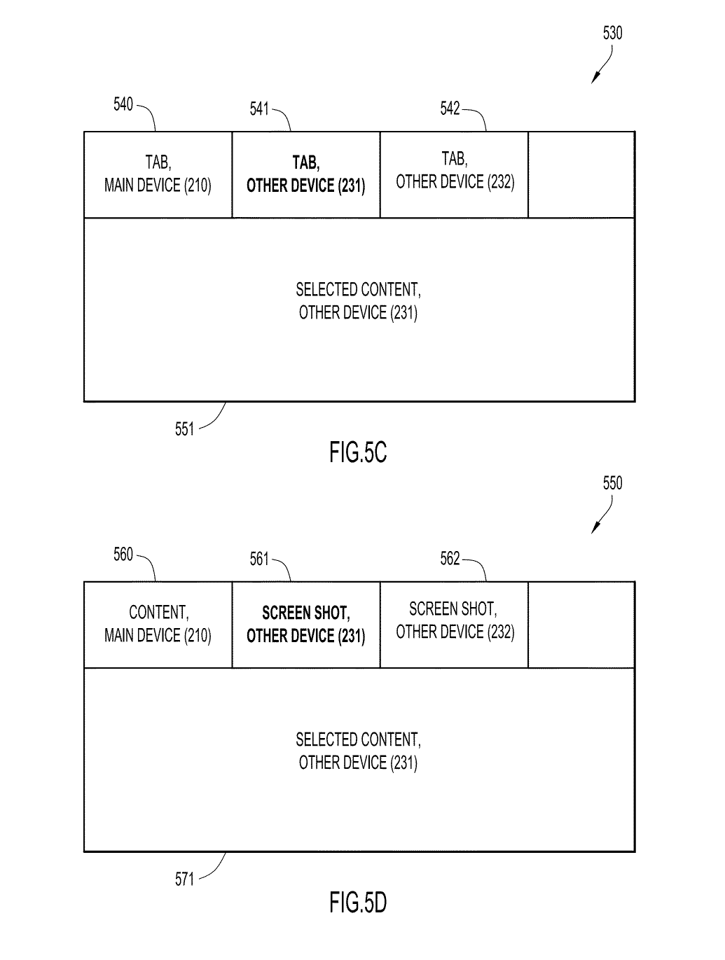

The arrangement of selected content on the display of the main device, described above with respect to 330 of FIG. 3, is illustrated according to various embodiments in FIGS. 5A-5D. In the embodiment of FIG. 5A, the display 500 of the main device shows separate sections 510, 511, and 512. Section 510 includes content that the presenter wishes to share, where this content originates from the main device itself (e.g., main device 210 of FIG. 2). Section 511 includes content selected from one of the other devices (such as device 231 of FIG. 2). Section 512 includes content selected from another device (such as device 231 of FIG. 2). The aggregated content of display 500, including the multiple sections 510-512, would be shared with participants in the web meeting.

In the embodiment of FIG. 5B, the display 520 of the main device shows separate sections in a different arrangement. Section 530 includes content that the presenter wishes to share, where this content originates from the main device (e.g., main device 210 of FIG. 2). Section 531 includes content selected from one of the other devices (such as device 231 of FIG. 2). Section 532 includes content selected from another device (such as device 232 of FIG. 2). Section 533 includes content selected from another device (such as device 233 of FIG. 2). The aggregated content of display 520, including the multiple sections 530-533, would be shared with participants in the web meeting.

In the embodiment of FIG. 5C, the display 530 of the main device shows content from one of the devices at a time. The user may select which content to show, using tabs 540-542. In this illustration, tab 541 has been chosen by the presenter. This tab corresponds to the content selected from one of the other devices (device 231 in this example). This content is shown in section 551 of display 530. Other tabs are also available, such as tab 540 (corresponding to content from the main device 210), and tab 542 (corresponding to content from other device 232). The content of section 551 would be shared with participants in the web meeting. In an embodiment, tabs 540-542 may also be visible to the participants.

In the embodiment of FIG. 5D, the display 550 of the main device again includes selectable tabs (here, tabs 560-562). In this embodiment, the tabs show scaled-down versions of content from the devices. In this illustration, tab 541 has been chosen by the presenter. This tab corresponds to the content selected from one of the other devices (device 231 in this example); the tab includes a screenshot of the content from this other device. This content is shown in section 571 of display 550. Other tabs are also available, such as tab 560 (corresponding to content from the main device 210), and tab 562 (corresponding to content from other device 232). Each of these tabs show the content from the corresponding devices. The content of section 571 would be shared with participants in the web meeting. In an embodiment, tabs 560-562 may also be visible to the participants.

The examples of FIGS. 5A-5D are meant to be illustrative embodiments and are not to be construed as limiting. As would be understood by a person of ordinary skill in the art, other embodiments are possible.

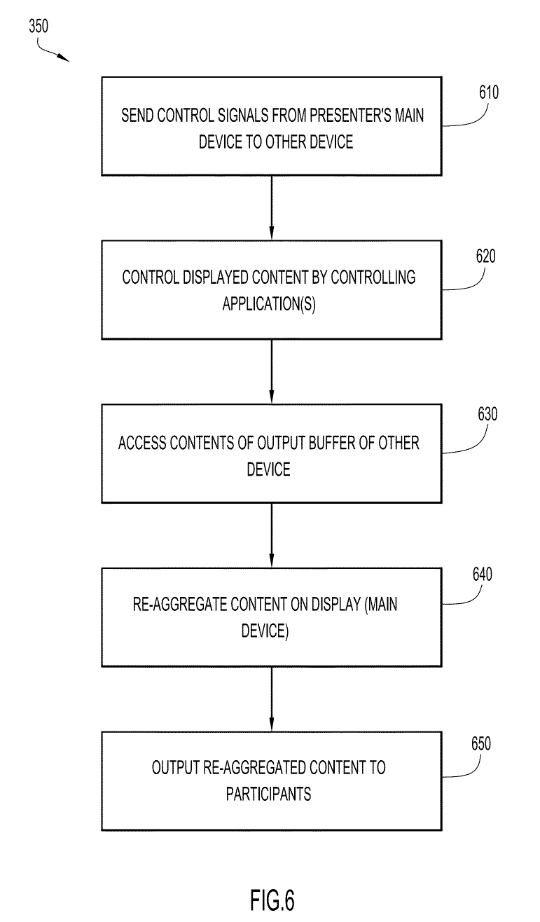

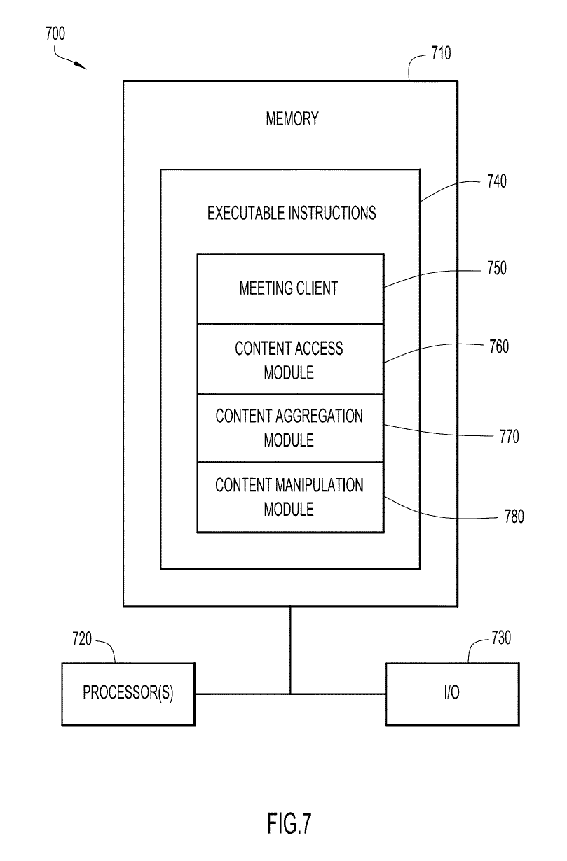

The manipulation of content (350 of FIG. 3) is illustrated in greater detail in FIG. 6, according to an embodiment. This manipulation is performed for purposes of the web conference, e.g., to highlight or edit information in the selected content, to explore the content, or to otherwise make a point about the content for the benefit of the conference participants. In an embodiment, the presenter provides inputs through a user interface at the main device. The user interface may include any of the displays of FIGS. 5A-5D, for example. The inputs are converted to control signals that, at 610, are sent from the main device to the other device to control an application at that device. The control signals are treated as user inputs to the application. At 620, the application executes to process the inputs, resulting in manipulation of the content.

The content at this stage therefore reflects any manipulations that may have been made, and may be displayed in this form at the other device. The manipulated content therefore resides in the output buffer of the other device. At 630, the contents of the output buffer of the other device are accessed by the main device. At 640 the content is re-aggregated and formatted at the main device along with the content of any other devices and/or with content from the main device. As described above with respect to the initial aggregation of content (330 of FIG. 3), the content in this situation may be formatted for display in a manner chosen by the presenter and/or in any manner known to persons of ordinary skill in the art. At 650, the collective re-aggregated content is output to the other participants in the web conference. As illustrated in FIG. 1, this transmission of content to the conference participants may take place via a conference server.

In an embodiment, processing at the main device is implemented in software or firmware. A software embodiment is illustrated in FIG. 7. Computing system 700 is part of the presenter's main device in an embodiment. System 700 includes one or more memory devices, shown collectively as memory 710. Memory 710 is in communication with one or more processors 720 and input/output ports and devices shown collectively as I/O 730. In one form, the I/O 730 is a network interface unit that enables communication over a network.

Memory 710 may comprise read only memory (ROM), random access memory (RAM), magnetic disk storage media devices, optical storage media devices, flash memory devices, electrical, optical, or other physical/tangible (i.e., non-transitory) memory storage devices. Memory 710 stores data as well as executable instructions 740. Instructions 740 are executable on processor(s) 720. The processor(s) 720 comprise, for example, a microprocessor or microcontroller that executes instructions 740. Thus, in general, the memory 710 may comprise one or more tangible (non-transitory) computer readable storage media (e.g., memory device(s)) encoded with software comprising computer executable instructions. When the software is executed (by the processor(s) 720) the software is operable to perform the operations described herein.

In the illustrated embodiment, the executable instructions 740 include several modules. These include a meeting client 750, which allows the main device to take part in a web conference. Instructions 740 also include a content access module 760, which enables the main device to control a meeting client and application(s) of another device of the presenter, to thereby select and obtain content from the other device. Instructions 740 also include a content aggregation module 770. This module allows the presenter to aggregate and format the selected content with content from the main device and from any other device of the presenter, for purposes of display to participants in the web conference. Instructions 740 also include a content manipulation module 780 that receives input from the presenter that manipulates content at the other device. The manipulated content can then be accessed and re-aggregated using logic in modules 760 and 770.

In an embodiment, I/O 730 comprises devices such as a mouse, keyboard, and display. I/O 730 also includes ports that serve as network connections, including connections to the Internet or other networks, and/or connections to the presenter's other devices.

The above description provides a method comprising: at a main computing device of a presenter in a web conference, joining the web conference; remotely taking control of a meeting client at each of one or more other computing devices external to the main computing device; selecting content at each of the other computing devices; at the main computing device, obtaining the selected content from the other computing devices; and from the main computing device; and presenting the selected content to conference participants in the web conference.

In another form, one or more computer readable non-transitory storage media are provided, encoded with software comprising computer executable instructions that when executed by a processor in a main computing device, cause the processor to: join a web conference; remotely take control of a meeting client at each of one or more other computing devices; select content at each of the other computing devices; obtain the selected content from the other computing devices; and present the selected content to conference participants in the web conference.

In still another form, an apparatus is provided comprising: a network interface unit that enables communication over a network; and a processor coupled to the network interface unit, that: remotely takes control of a meeting client at each of one or more other computing devices external to a main computing device, to select content at each of the one or more other computing devices, and to obtain the selected content from each of the one or more other computing devices; and joins a web conference and to present the selected content collectively in the web conference to conference participants.

While various embodiments are disclosed herein, it should be understood that they have been presented by way of example only, and not limitation. It will be apparent to persons skilled in the relevant art that various changes in form and detail may be made therein without departing from the spirit and scope of the methods and systems disclosed herein. Functional building blocks are used herein to illustrate the functions, features, and relationships thereof. At least some of the boundaries of these functional building blocks have been arbitrarily defined herein for the convenience of the description. Alternate boundaries may be defined so long as the specified functions and relationships thereof are appropriately performed. The breadth and scope of the claims should not be limited by any of the example embodiments disclosed herein.

What is claimed is:

1. A method comprising:
at a main computing device of a presenter in a web conference, joining the web conference;
remotely taking control of a meeting client at each of one or more other computing devices external to the main computing device;
at the main computing device, obtaining selected content from each of the one or more the other computing devices; and
presenting the selected content collectively to conference participants in the web conference.

2. The method of claim 1, wherein the selected content comprises a file stored at one of the other computing devices.

3. The method of claim 1, wherein the selected content comprises content that is streamed to one of the other computing devices.

4. The method of claim 1, wherein obtaining the selected content comprises reading one or more output buffers of the respective one or more other computing devices.

5. The method of claim 1, further comprising:
aggregating the selected content at the main computing device,
performed prior to the presentation of the selected content to the conference participants.

6. The method of claim 5, wherein aggregating the selected content comprises:
arranging the selected content on a display the main computing device,
wherein the arranging is performed on the basis of input from the presenter.

7. The method of claim 1, further comprising:
manipulating the selected content on the basis of input from the presenter at the main computing device,
wherein manipulating the selected content comprises sending control signals to one of the other computing devices,
wherein the control signals correspond to the input from the presenter at the main computing device, and
wherein the control signals are configured to control an application that is executing on the other computing device and that is outputting at least a portion of the selected content.

8. One or more computer readable non-transitory storage media encoded with software comprising computer executable instructions that when executed by a processor of a main computing device, cause the processor to:
join a web conference;
remotely take control of a meeting client at each of one or more other computing devices;
obtain selected content from each of the one or more other computing devices; and
present the selected content collectively to conference participants in the web conference.

9. The computer readable storage media of claim 8, wherein the selected content comprises a file stored at one of the other computing devices.

10. The computer readable storage media of claim 8, wherein the selected content comprises content streamed to one of the other computing devices.

11. The computer readable storage media of claim 8, wherein the obtaining of the selected content comprises reading one or more output buffers of the respective one or more other computing devices.

12. The computer readable storage media of claim 8, further comprising computer executable instructions that when executed by a processor, cause the processor to:
aggregate the selected content at the main computing device,
performed prior to the presenting of the selected content to the conference participants.

13. The computer readable storage media of claim 12, wherein the instructions that cause the processor to aggregate the selected content comprise instructions for:
arranging the selected content on a display of the main computing device,
wherein the arranging is performed on the basis of input from the presenter.

14. The computer readable storage media of claim 8, further comprising computer executable instructions that when executed by a processor, cause the processor to:
manipulate the selected content on the basis of input from the presenter at the main computing device, by sending control signals to one of the other computing devices,
wherein the control signals correspond to the input from the presenter at the main computing device, and
wherein the control signals are configured to control an application that is executing on the other computing device and that is outputting at least a portion of the selected content.

15. An apparatus comprising:
a network interface unit that enables communication over a network; and
a processor coupled to the network interface unit, that:
remotely takes control of a meeting client at each of one or more other computing devices external to a main computing device, to select content at each of the one or more other computing devices, and to obtain the selected content from each of the one or more other computing devices; and
joins a web conference and to present the selected content collectively in the web conference to conference participants.

16. The main computing device of claim 15, wherein the selected content comprises a file stored at one of the other computing devices.

17. The main computing device of claim 15, wherein the selected content comprises content streamed to one of the other computing devices.

18. The main computing device of claim 15, wherein the processor obtains the selected content by reading one or more output buffers of the respective one or more other computing devices.

19. The main computing device of claim 15, wherein the processor aggregates the selected content at the main computing device, prior to the presentation of the selected content to the conference participants.

20. The main computing device of claim 19, wherein the processor arranges the selected content on a display of the main computing device, on the basis of input from the presenter.

21. The main computing device of claim 15, wherein the processor:
manipulates the selected content on the basis of input from the presenter at the main computing device, by sending control signals to one of the other computing devices,
wherein the control signals correspond to the input from the presenter at the main computing device, and
wherein the control signals are configured to control an application that is executing on the other computing device and that is outputting at least a portion of the selected content.
